(19) United States
(12) Patent Application Publication
(10) Pub. No.: US 2022/0229707 A1
(43) Pub. Date: Jul. 21, 2022

(54) MANAGING MIGRATION OF WORKLOAD RESOURCES

(71) Applicant: Hewlett Packard Enterprise Development LP, Houston, TX (US)

(72) Inventors: Klaus-Dieter Lange, Houston, TX (US); Nishant Rawtani, Bangalore Karnataka (IN); Supriya Kamthania, Bangalore Karnataka (IN)

(21) Appl. No.: 17/248,315

(22) Filed: Jan. 20, 2021

(51) Int. Cl. G06F 9/50

(52) U.S. Cl. CPC G06F 9/5088

(57) ABSTRACT

Examples described herein relate to a management node and a method for managing migration of workload resources. The management node may assign a capability tag to each of a plurality of member nodes hosting workload resources. Further, the management node may determine a resource requirement classification of each workload resource of the workload resources based on analysis of runtime performance data of each workload resource. Furthermore, the management node may determine a temporal usage pattern classification of each workload resource. Moreover, the management node may determine a migration plan for a candidate workload resource of the workload resources based on the capability tag of each of the plurality of member nodes, the resource requirement classification and the temporal usage pattern classification of each workload resource.

### BACKGROUND

Data may be stored on computing nodes, such as a server, a storage array, a cluster of servers, a computer appliance, a workstation, a storage system, a converged system, a hyperconverged system, or the like. The computing nodes may host workload resources that may generate or consume the data during their respective operations. Examples of the workload resources may include an application (e.g., software program), a virtual machine (VM), a container, a pod, a database, a data store, a logical disk, or a containerized application.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 depicts a networked system including a plurality of member nodes and a management node for managing migration of a workload resource among the plurality of the member nodes, in accordance with an example;

FIG. 2 depicts the networked system of FIG. 1 after candidate workload resources are migrated to respective target member nodes, in accordance with an example;

FIG. 3 is a flow diagram depicting a method for migrating a workload resource, in accordance with an example;

FIG. 4 is a flow diagram depicting a method for migrating a workload resource, in accordance with another example; and

FIG. 5 is a block diagram depicting a processing resource and a machine-readable medium encoded with example instructions to migrating a workload resource, in accordance with an example.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, fourth, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Data may be stored and/or processed in computing nodes, such as a server, a storage array, a cluster of servers, a computer appliance, a workstation, a storage system, a converged system, a hyperconverged system, or the like. The computing nodes may host and execute workload resources that may generate and/or consume the data during their respective operations. Examples of such workload resources may include, but are not limited to, an application (e.g., software program), a virtual machine (VM), a container, a pod, a database, a data store, a logical disk, or a containerized application.

In some examples, workload resources may be managed via a workload resource-orchestration system (hereinafter referred to as an orchestration system). For example, workload resources such as pods may be managed via a container orchestration system such as Kubernetes. The orchestration system may be operational on (in other words, executing or running on or as) a computing node, dedicated process, and/or container, hereinafter referred to as a management node. The management node may receive a workload resource deployment request to deploy a workload resource and schedule deployment of the workload resource on one or more of other computing nodes, hereinafter referred to as, member nodes. In some instances, the management node may deploy one or more replicas of the workload resources on several member nodes to enable high availability of the workload resources. The member nodes may facilitate resources, for example, compute, storage, and/or networking capability, for the workload resources to execute workloads. The management node and the member nodes may form a networked system.

In some examples, in the networked system, the management node may also manage migration of the workload resources based on an operating status of the member nodes. The scheduling (e.g., deployment) and/or migration of the workload resources may be managed to address the need for rapid deployment of services, at cloud scale, keeping in mind factors like agility, ease of application upgrades or rollbacks and cloud-native workload resources. In certain implementations, some of the member nodes in the networked system may include premium hardware. For example, due to wider adoption of containers in several enterprises, member nodes in state of the art Kubernetes clusters may include premium hardware to run business critical workloads. In order to achieve maximum return on investment (ROI) and reduced or lowest total cost of ownership (TCO), execution of the workload resources on the right kind of hardware is desirable. This is possible when placement and/or migration of the workload resources are optimal, i.e., workload resources are deployed on the member nodes having the right kind of hardware.

Certain versions of container orchestration systems such as Kubemetes may support a node feature discovery capability (which may be implemented as an add-in) that enables the member nodes to detect and advertise/publish hardware and software capabilities of the respective member node. The published hardware and software capabilities of the member nodes can in turn be used by a scheduler running on the management node to facilitate intelligent scheduling of workload resources. However, hardware and software capabilities published by the member nodes may be too granular and/or provide excessive information that may be difficult to analyze and arrive at scheduling and/or migration decisions. Use of each of the hardware and software capabilities or even selection of right kind of hardware and software capabilities for taking scheduling decision has been a challenging task.

Further, in some examples, workloads running on the workload resources may offer several functionalities that may be offered as “as-a-service” to several users. For example, a container management platform capable of managing multitude of containers/pods based on Kubemetes may be offered in the form of a software-as-a-service (SaaS) in a public cloud, in a private cloud, or in a hybrid cloud model on pay-per-use basis. In some instances, to adopt to such new SaaS model offering the services on the pay-per-use basis, several workload resources may be migrated from one information technology (IT) set-up (e.g., a data center) to another IT set-up. Sometimes, in traditional IT set-ups, certain workload resources may be overprovisioned. Therefore, when such workload resources are migrated from the traditional IT set-ups to a target IT set-up facilitating as-a-service deployment, the workload resources may be migrated with the respective existing overprovisions leading to inefficient resource allocations on the target IT set-ups. Moreover, due to such “lift and shift” migrations with the overprovisioned workload resources, the customers may also end-up paying extra costs in comparison to their existing legacy environments.

Furthermore, in some instances, the workload resources may have different resource utilizations based on the types of workloads running thereon. For example, a workload resource running CPU and memory workloads (e.g., machine learning (ML), integer, floating point operations) may utilize more compute power, whereas another workload resource running storage-centric database workloads (e.g., SQL server, SAP HANA) may utilize more storage from a respective member node. In some instances, a performance of a given workload may be adversely impacted if a workload resource running the given workload is placed on hardware that is not tuned or optimized for a given workload type. In such case, to achieve the customer's Service Level Agreement (SLA) requirements, additional compute and storage may be provisioned to the workload resource, thereby increasing the overall hardware cost, which, in turn, may increase the capital expenditure of in the networked system.

Additionally, in certain instances, the workload resources may display different usage patterns. In some examples, the workload resources may have different utilization levels at different time intervals based upon their characteristics of the workloads running thereon. For example, a periodic workload may have high utilization of system resources during working hours of the day and can lie dormant during the night. When containers hosting such periodic workloads are placed statically on the same hardware, it can lead to inefficient use of system resources, leading to increased operational expenditure due to higher datacenter power and cooling requirements, for example.

To that end, in accordance with aspects of the present disclosure, a management node is presented that facilitates intelligently managed runtime migration of workload resources taking into consideration parameters such as, for example, performance characteristics of the member nodes, resource requirement classifications, and temporal usage pattern classifications of the workload resources running on the member nodes of a networked system. In some examples, the management node may assign a capability tag to each of a plurality of member nodes hosting workload resources. The management node may determine the capability tag for each of the plurality of member nodes based on platform capability data published by each of the plurality of member nodes. Accordingly, in some examples, the capability tag assigned to a given member node may represent a dominant performance characteristic of the given worker node. Examples of the capability tag that may be assigned to the given member node may include, but are not limited to, high-performance compute, graphics capable, low-latency capable, database expert system, power efficient compute, high throughput compute, virtualization efficient system, or special purpose system.

Further, in some examples, the management node may determine a resource requirement classification of each workload resource of the workload resources based on analysis of runtime performance data of each workload resource. The resource requirement classification of a given workload resource may be indicative of a resource type that the given workload resource primarily uses during its operation. Examples of the resource requirement classification may include, but are not limited to, database intense, memory intense, compute intense, graphics intense, or low-latency demanding. Moreover, the management node may determine a temporal usage pattern classification of each workload resource. The temporal usage pattern classification for a given workload resource may represent a temporal usage pattern of the given workload resource determined based on time series analysis of the performance data (e.g., usage) of the given workload resource.

Additionally, in some examples, the management node may determine a migration plan for a candidate workload resource of the workload resources based on the capability tag of each of the plurality of member nodes, the resource requirement classification and the temporal usage pattern classification of each workload resource. The migration plan may include a list of one or more candidate workload resources, if any, that are identified to be migrated. The migration plan may also include target member nodes to which the one or more candidate workload resources are to be migrated. In some examples, the migration plan may also include a time-schedule for migrating corresponding to the one or more candidate workload resources. Once the migration plan is determined, the management node may cause migration of the candidate workload resource(s) to the respective target member nodes at the respective determined time-schedule.

As will be appreciated, the management node and the methods presented herein facilitates enhanced migration of workload resources according to a migration plan that is determined based on capability tags that are automatically determined based on platform capability data published by each of the plurality of member nodes, the resource requirement classifications and the temporal usage classifications of the workload resources. Advantageously, by causing the migration of candidate workload resources based on such a migration plan, a user can run workload resources executing business applications with awareness of member nodes' hardware and software capabilities and/or vulnerabilities while taking into account resource requirement classifications and the temporal usage pattern classifications of the workload resources. In particular, enhanced migration of the workload resources as caused by the management node, in some examples, may advantageously place the workload resources on a well-equipped member node having sufficient resources (e.g., hardware and software) to fulfill requirements of the workload resources.

Further, the migration of the workload resources based on the values of the capability tags and the resource requirement classifications may enable enhanced performance and security for the workload resources on networked systems (e.g., Kubernetes clusters) either in a customer's on-premise private cloud datacenter owned, leased by the customer, or consumed as a vendor's as-a-service offering (e.g., through a pay-per-use or consumption-based financial model). In particular, the migration of the workload resources caused in this way may result in the workload resource running on a right kind of hardware. Consequently, allocation of additional compute and storage to the workload resources may be minimized, thereby reducing the overall hardware cost, which, in-turn, may decrease the capital expenditure of in the networked system.

Moreover, the migration plan that is generated by the management node for a given candidate workload resource is also based on a temporal usage pattern classification of the given candidate workload. In particular, in some examples, the migration plan may cause a migration of the candidate workload resource during a time period when the given candidate workload is inactive or idle. For example, the workload resource that are periodic in nature may be migrated to low-power or less compute intensive member nodes when such periodic workload resources are inactive or idle. Such migration of the workload resources according to respective temporal usage pattern classifications may ensure that the workload resources are not placed statically on the same hardware, thereby reducing the operational expenditure by lowering power and cooling requirements in the networked system, for example. Moreover, as the workload resources are migrated when the workload resources are inactive or idle, impact to the performance of the workload resources and violations of SLAs may be avoided.

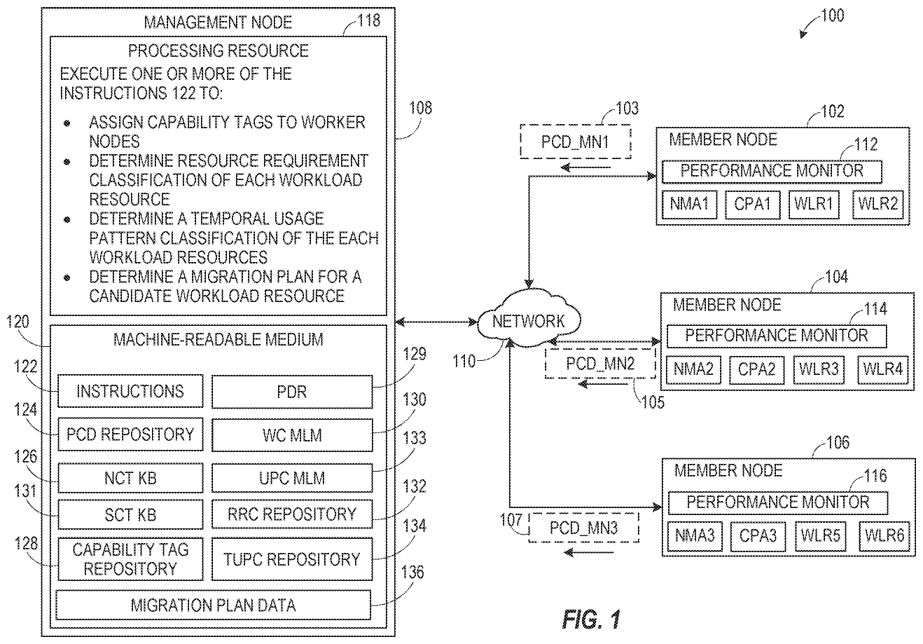

Referring now to the drawings, in FIG. 1, a networked system 100 is depicted, in accordance with an example. The networked system 100 may include a plurality of member nodes 102, 104, and 106, hereinafter, collectively referred to as member nodes 102-106. Further, the networked system 100 may also include a management node 108 coupled to the member nodes 102-106 via a network 110. In some examples, the networked system 100 may be a distributed system where one or more of the member nodes 102-106 and the management node 108 are located at physically different locations (e.g., on different racks, on different enclosures, in different buildings, in different cities, in different countries, and the like) while being connected via the network 110. In certain other examples, the networked system 100 may be a turnkey solution or an integrated product. In some examples, the terms “turnkey solution” or “integrated product” may refer to a ready for use packaged solution or product where the member nodes 102-106, the management node 108, and the network 110 are all disposed within a common enclosure or a common rack. Moreover, in some examples, the networked system 100 in any form, be it the distributed system, the turnkey solution, or the integrated product, may be capable of being reconfigured by adding or removing member nodes and/or by adding or removing internal resources (e.g., compute, storage, network cards, etc.) to and from the member nodes 102-106 and the management node 108.

Examples of the network 110 may include, but are not limited to, an Internet Protocol (IP) or non-IP-based local area network (LAN), wireless LAN (WLAN), metropolitan area network (MAN), wide area network (WAN), a storage area network (SAN), a personal area network (PAN), a cellular communication network, a Public Switched Telephone Network (PSTN), and the Internet. In some examples, the network 110 may include one or more network switches, routers, or network gateways to facilitate data communication. Communication over the network 110 may be performed in accordance with various communication protocols such as, but not limited to, Transmission Control Protocol and Internet Protocol (TCP/IP), User Datagram Protocol (UDP), IEEE 802.11, and/or cellular communication protocols. The communication over the network 110 may be enabled via a wired (e.g., copper, optical communication, etc.) or wireless (e.g., Wi-Fi*, cellular communication, satellite communication, Bluetooth, etc.) communication technologies. In some examples, the network 110 may be enabled via private communication links including, but not limited to, communication links established via Bluetooth, cellular communication, optical communication, radio frequency communication, wired (e.g., copper), and the like. In some examples, the private communication links may be direct communication links between the management node 108 and the member nodes 102-106.

Each of the member nodes 102-106 may be a device including a processor or microcontroller and/or any other electronic component, or a device or system that may facilitate various compute and/or data storage services. Examples of the member nodes 102-106 may include, but are not limited to, a desktop computer, a laptop, a smartphone, a server, a computer appliance, a workstation, a storage system, or a converged or hyperconverged system, and the like. In FIG. 1, although the networked system 100 is shown to include three member nodes 102-106, the networked system 100 may include any number of member nodes, without limiting the scope of the present disclosure. The member nodes 102-106 may have similar or varying hardware and/or software configurations in a given implementation of the networked system 100. By way of example, while some member nodes may have high-performance compute capabilities, some member nodes may facilitate strong data security, some member nodes may facilitate low-latency data read and/or write operations, certain member nodes may have enhanced thermal capabilities, some member nodes may be good at handling database operations, or some member nodes may be good at handling graphics processing operations.

The member nodes 102-106 may facilitate resources, for example, compute, storage, and/or networking capabilities, for one or more workload resources to execute thereon. The term workload resource may refer to a computing resource including, but not limited to, an application (e.g., software program), a virtual machine (VM), a container, a pod, a database, a data store, a logical disk, or a containerized application. As will be understood, a workload resource such as a VM include an instance of an operating system hosted on a given member node via a VM host program such as a hypervisor. Further, a workload resource such as a container may be an application packaged with its dependencies (e.g., operating system resources, processing allocations, memory allocations, etc.) hosted on a given member node via a container host program such as a container runtime (e.g., Docker Engine), for example. Further, in some examples, one or more containers may be grouped to form a pod. For example, a set of containers that are associated with a common application may be grouped to form a pod. A workload resource may execute one or more workloads (e.g., software program) for one or more applications (e.g., a banking application, a social media application, an online marketplace application, a website). It is to be noted that the scope of the present disclosure is not limited with respect to a type of the workload, a use of the workloads, functionalities, and/or features offered by the workloads.

In the description hereinafter, the workload resources are described as being pods for illustration purposes. Pods may be managed via a container-orchestration system such as, for example, Kubemetes. In the example of FIG. 1, the member node 102 is shown to host workload resources WLR1 and WLR2, the member node 104 is shown to host workload resources WLR3 and WLR4, and the member node 106 is shown to host workload resources WLR5 and WLR6. Although certain number of workload resources are shown as being hosted by each of the member nodes 102-106 as depicted in FIG. 1, the member nodes 102-106 may host any number of workload resources depending on respective hardware and/or software configurations.

Further, in some examples, one or more of the member nodes 102-106 may host a node-monitoring agent (NMA) and a capability publisher agent (CPA). In the example of FIG. 1, the member node 102 is shown to host NMA1 and CPA1, the member node 104 is shown to host NMA2 and CPA2, and the member node 106 is shown to host NMA3 and CPA3. The node-monitoring agents NMA1, NMA2, and NMA3 and the capability publisher agents CPA1, CPA2, and CPA3 may represent a workload resource (e.g., a pod) being executed on the respective member nodes 102-106. For the sake of brevity, operations of the node-monitoring agent NMA1 and the capability publisher agent CPA1 hosted on the member node 102 will be described hereinafter. The node-monitoring agents NMA2 and NMA3 may perform similar operations on respective member nodes 104, 106 as performed by the node-monitoring agent NMA1 on the member node 102. In addition, the capability publisher agents CPA2 and CPA3 may perform similar operations on respective member nodes 104, 106 as performed by the capability publisher agents CPA1 on the member node 102.

During commissioning and/or real-time operation of the member node 102, the node-monitoring agent NMA1 may monitor the hardware and/or software of the member node 102 to collect information regarding several platform capabilities of the member node 102. A platform capability may include a key-value pair, where a key may include platform capability label and a value may include a setting corresponding to the platform capability label. The platform capability labels that are monitored by the node-monitoring agent NMA1 may include, but are not limited to, one or more of power regulator setting (PR setting), minimum processor idle power core C-state (PIPC_C-state), minimum processor idle power package C-state (PIPP_C-state), energy performance bias setting (EPB setting), collaborative power control setting (CPC setting), DMI link frequency setting (DMILF setting), turbo boost technology setting (TBT setting), NIC DMA channels (IOAT) setting, hardware pre-fetcher setting (HPF setting), adjacent sector pre-fetch setting (ASPF setting), DCU Stream Pre-fetcher setting (DCU SPF setting), NUMA group size optimization setting (NUMA GSO setting), UPI link power management setting (UPI LPM setting), memory patrol scrubbing setting (MPS setting), sub-NUMA clustering setting (s-NUMAC setting), memory refresh rate (MRR), energy-efficient turbo setting (EET setting), uncore frequency shifting setting (UFS setting), channel interleaving setting (CI setting), advance memory protection setting (AMP setting), or the like. In some examples, the node-monitoring agent NMA1 may obtain settings associated with one or more of the abovementioned platform capability labels from basic input-output system (BIOS) by executing one or more application programming interfaces (APIs), for example, Redfish APIs. In some examples, to monitor various platform capability labels of the member node 102, the node-monitoring agent NMA1 may execute one or more commands.

Table-1 presented below depicts one or more of the above platform capabilities including platform capability labels and corresponding example settings.

TABLE 1
Example platform capability
labels and respective example settings

| Platform | |
|---|---|
| Capability Label | Example Settings |
| Minimum PIPC_C-state | C6, No C-state |
| Minimum PIPP_C-state | Package C6 retention (PCR), |
| | No C-state (NC) |
| PR setting | Dynamic Power Savings (DPS), |
| | OS Control (OSC), |
| | Static High-performance (SHP) |
| EPB setting | Balanced Performance (BP), Max |
| | Performance (MP) |
| CPC setting | Enabled, Disabled |
| DMILF setting | Auto, Max, Min |
| TBT setting | Enabled, Disabled |
| IOAT setting | Enabled, Disabled |
| HPF setting | Enabled, Disabled |
| ASPF setting | Enabled, Disabled |
| DCU SPF setting | Enabled, Disabled |
| NUMA GSO setting | Flat, Clustered |
| UPI LPM setting | Enabled, Disabled |
| MPS setting | Enabled, Disabled |
| s-NUMAC setting | Enabled, Disabled |
| MRR | 1X |
| EET setting | Enabled, Disabled |
| UFS setting | Auto, Max, Min |
| CI setting | Enabled, Disabled |
| AMP setting | Adaptive Double DRAM Device |
| | Correction (ADDDC), Error |
| | Correction Coding (ECC), Disabled |

It is to be noted that Table-1 does not contain exhaustive list of the platform capability labels that can be monitored by the node-monitoring agent NMA1. Also, in some examples, a given platform capability label of the member node 102 may have additional or different possible settings than the ones shown in Table-1. In a given implementation of the networked system 100, to achieve a predetermined performance, a given member node might have been tuned by configuring the respective platform capability labels to one of the respective example settings (e.g., the example settings shown in Table-1). Accordingly, during the monitoring by the node-monitoring agent NMA1, the node-monitoring agent NMA1 may obtain the configured settings of the one or more platform capability labels of the member node 102.

In some examples, the capability publisher agent CPA1 may publish the platform capability data of the member node 102 monitored by the node-monitoring agent NMA1. In some examples, publishing of the capability data may include communicating the platform capability labels and their respective settings to the management node 108 by the capability publisher agent CPA1. In certain other examples, the publishing of the platform capability labels and their respective settings may include storing the platform capability labels and their respective settings in a storage media accessible by the management node 108. In some examples, the capability publisher agent CPA1 may publish the platform capability labels and their respective settings by way of sending platform capability data 103 (labeled as PCD_MN1 in FIG. 1) corresponding to the member node 102 to the management node 108 via the network 110. The platform capability data 103 may include key-value pairs, for example, the platform capability labels (e.g., a power regulator setting) and their respective settings (e.g., static high-performance) corresponding to the member node 102. Similarly, the capability publisher agents CPA2 and CPA3 may also send platform capability data 105 (labeled as PCD_MN2 in FIG. 1) and 107 (labeled as PCD_MN3 in FIG. 1) of the member nodes 104 and 106, respectively, to the management node 108. The platform capability data 105 and 107 may include key-value pairs, for example, the platform capability labels and their respective settings for the member nodes 104, and 106, respectively.

Further, in some examples, one or more of the member nodes 102-106 may also host a performance monitor. In the example of FIG. 1, the member node 102 is shown to host a performance monitor 112, the member node 104 is shown to host a performance monitor 114, and the member node 106 is shown to host a performance monitor 116. The performance monitors 112-116 may represent one type of a workload resource (e.g., a pod or a container) running on the respective member nodes 102-106 that monitor runtime performance data of the workload resources running on the respective member nodes 102-106. For the sake of brevity, operations of the performance monitor 112 hosted on the member node 102 will be described hereinafter. The performance monitor 114 and performance monitor 116 may perform similar operations on respective member nodes 104, 106 as performed by the performance monitor 112 on the member node 102.

In some examples, the performance monitor 112 may collect performance data of each workload resource hosted on the member node 102 using various sources. In one example, the performance monitor 112 may use REST APIs exposed by container management platform such as Docker Daemon to obtain the performance data of each workload resource. In some examples, the performance monitor 112 may collect performance data of each workload resource by executing performance data collection commands such as “docker stats.” In some other examples, the performance monitor 112 may read one or more files, such as, cgroups pseudo files corresponding to the workload resources to collect performance data. It is to be noted that the performance monitor 112 may generate different datasets corresponding to one or more of the REST APIs, docker stats command, or the cgroups pseudo files and send the datasets to the management node 108 in a suitable form, including but not limited to, a JSON or a CSV format. In some examples, the performance data may also include data representing temporal utilization of each workload resource.

The management node 108 may obtain the platform capability data (e.g., platform capability labels and respective settings) for each of member nodes 102-106 and the performance data corresponding to the workload resources (e.g., one or more of the workload resources WLR1-WLR6) from the respective member nodes 102-106. In some examples, the management node 108 may manage migration of the one or more candidate workload resources, if identified, to another different member nodes based on the received platform capability data of the member nodes 102-106 and the performance data of the workload resources WLR1-WLR6. As depicted in FIG. 1, in some examples, the management node 108 may be a device including a processor or microcontroller and/or any other electronic component, or a device or system that may facilitate various compute and/or data storage services, for example. Examples of the management node 108 may include, but are not limited to, a desktop computer, a laptop, a smartphone, a server, a computer appliance, a workstation, a storage system, or a converged or hyperconverged system, and the like that is configured to manage deployment of workload resources. Further, in certain examples, the management node 108 may be a virtual machine or a containerized application executing on hardware in the networked system 100. In one example, the management node 108 may be implemented as a virtual machine or a containerized application on any of the member nodes 102-106 in the networked system 100.

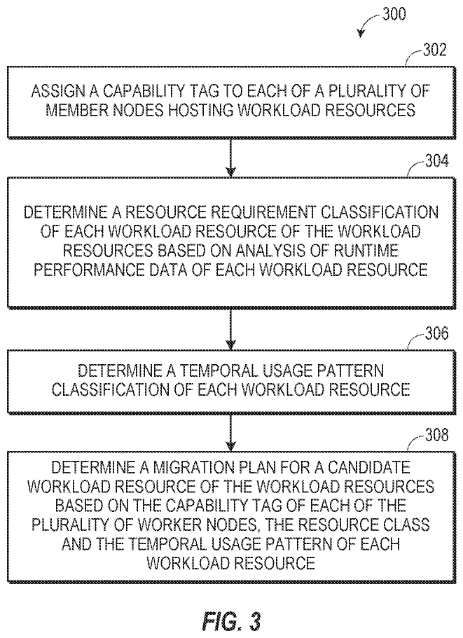

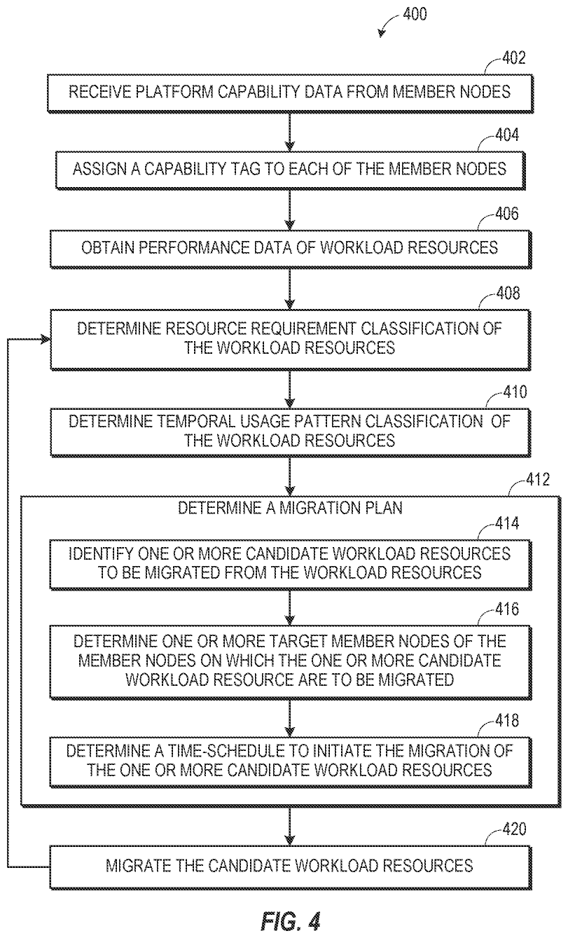

In some examples, the management node 108 may include a processing resource 118 and a machine-readable medium 120. The machine-readable medium 120 may be any electronic, magnetic, optical, or other physical storage device that may store data and/or executable instructions 122. For example, the machine-readable medium 120 may include one or more of a Random Access Memory (RAM), an Electrically Erasable Programmable Read-Only Memory (EEPROM), a storage drive, a flash memory, a Compact Disc Read Only Memory (CD-ROM), and the like. The machine-readable medium 120 may be non-transitory. As described in detail herein, the machine-readable medium 120 may be encoded with the executable instructions 122 to perform one or more methods, for example, methods described in FIGS. 3 and 4.

Further, the processing resource 118 may be a physical device, for example, one or more central processing unit (CPU), one or more semiconductor-based microprocessors, one or more graphics processing unit (GPU), application-specific integrated circuit (ASIC), a field programmable gate array (FPGA), other hardware devices capable of retrieving and executing instructions 122 stored in the machine-readable medium 120, or combinations thereof. The processing resource 118 may fetch, decode, and execute the instructions 122 stored in the machine-readable medium 120 to manage deployment of a workload resource (described further below). As an alternative or in addition to executing the instructions 122, the processing resource 118 may include at least one integrated circuit (IC), control logic, electronic circuits, or combinations thereof that include a number of electronic components for performing the functionalities intended to be performed by the management node 108 (described further below). Moreover, in certain examples, where the management node 108 may be a virtual machine or a containerized application, the processing resource 118 and the machine-readable medium 120 may represent a processing resource and a machine-readable medium of the hardware or a computing system that hosts the management node 108 as the virtual machine or the containerized application.

During operation, the processing resource 118 may obtain the platform capability data 103, 105, and 107 from the member nodes 102, 104, 106, respectively, and store the received platform capability data 103, 105, and 107 into the machine-readable medium 120 as a platform capability data repository 124. In some examples, the processing resource 118 may obtain the platform capability data 103, 105, and 107 respectively from the member nodes 102, 104, 106, periodically, at random intervals, on demand, and/or upon any configuration (e.g., hardware, software, orfirmware) change ofthe membernodes 102-106. Example content stored in the platform capability data repository 124 is presented in Table-2 below.

TABLE 2
Example content of in the
platform capability data repository 24

| Platform | Settings for | Settings | Settings |
|---|---|---|---|
| Capability | member | for | for |
| Labels | node (MN) 102 | MN 104 | MN 106 |
| PR setting | SHP | | SHP |
| Min. PIPC_C-state | NC | | NC |
| Min. PIPP_C-state | NC | | NC |
| EPB setting | MP | MP | MP |
| CPC setting | Disabled | | Disabled |
| DMILF setting | Auto | Auto | Auto |
| TBT setting | Enabled | | Disabled |
| IOAT setting | | Enabled | |
| HPF setting | Enabled | Enabled | Enabled |
| ASPF setting | Enabled | Enabled | Enabled |
| DCU SPF setting | Enabled | Enabled | Enabled |
| NUMA GSO setting | Clustered | Clustered | Clustered |
| UPI LPM setting | Disabled | | Disabled |
| MPS setting | | | Disabled |
| s-NUMAC setting | Enabled | | Enabled |
| MRR | 1X | | 1X |
| EET setting | Disabled | | Disabled |
| UFS setting | | Max | |
| CI setting | Enabled | Enabled | Enabled |
| AMP setting | ADDDC | ADDDC | ECC |

In one example, Table-2 depicts a consolidated platform capability data including the platform capability labels (e.g., in the first column) and their respective settings corresponding to the member nodes 102-106, respectively in the second, third, and fourth column. Although not shown, the platform capability data repository 124 may also include platform capability labels and their respective settings corresponding to any additional member nodes present in the networked system 100 and managed by the management node 108.

Further, in some examples, the processing resource 118 may also store and manage (e.g., allow user updates or customizations) a node capability tag knowledge base 126 (labeled as NCT KB 126) in the machine-readable medium 120. The node capability tag knowledge base 126 may include a mapping between one or more predefined configurations of the platform capability labels and capability tags. Table-3 presented below represents example content of the node capability tag knowledge base 126 in the form of a look-up table stored in the machine-readable medium 120.

TABLE 3
Example content of in the node capability tag knowledge
base 126

| | Capability Tags | | |
|---|---|---|---|
| | High- | | |
| | performance | Graphics | Low-latency |
| | Compute | Capable | capable |
| Platform | Configuration | Configuration | Configuration |
| Capability | 1 | 2 | 3 |
| PR setting | SHP | | SHP |
| Min. PIPC_C-state | NC | | NC |
| Min. PIPP_C-state | NC | | NC |
| EPB setting | MP | MP | MP |
| CPC setting | Disabled | | Disabled |
| DMILF setting | Auto | Auto | Auto |
| TBT setting | Enabled | | Disabled |
| IOAT setting | | Enabled | |
| HPF setting | Enabled | Enabled | Enabled |
| ASPF setting | Enabled | Enabled | Enabled |
| DCU SPF setting | Enabled | Enabled | Enabled |
| NUMA GSO setting | Clustered | Clustered | Clustered |
| UPI LPM setting | Disabled | | Disabled |
| MPS setting | | | Disabled |
| s-NUMAC setting | Enabled | | Enabled |
| MRR | 1X | | 1X |
| EET setting | Disabled | | Disabled |
| UFS setting | | Max | |
| CI setting | Enabled | Enabled | Enabled |
| AMP setting | ADDDC | ADDDC | ECC |

It is to be noted that Table-3 depicts three example configurations (e.g., configuration 1, configuration 2, and configuration 3) of the platform capability labels (listed in column 1 of Table-3) and corresponding example capability tags (e.g., high-performance compute, graphics capable, and low-latency capable) for illustration purposes and for the sake of brevity. Although, the content of the node capability tag knowledge base 126 is shown in the form of the Table-3, the content of the node capability tag knowledge base 126 may be stored in any suitable form including but not limited to, a syntax or a script. Further, the configurations presented in Table-3 are defined based on previously described example platform capability labels that can be monitored from the member nodes 102-106. In certain other examples, the configurations may be defined based different, additional, and/or fewer platform capability labels and respective settings than those illustrated in Table-3, without limiting the scope of the present disclosure. Although not shown in Table-3, in some examples, the node capability tag knowledge base 126 may also include additional configurations and respective capability tags. Examples of the capability tags corresponding to which the configurations can be included in the node capability tag knowledge base 126 may include, but are not limited to, database expert system, power efficient compute, high throughput compute, virtualization efficient system, special purpose system, and the like.

In some examples, the processing resource 118 may store a unique configuration corresponding to each of the capability tags in the node capability tag knowledge base 126. By way of example, the configuration 1 defining the capability tag—“high-performance compute” may be defined by a unique combination of settings presented in column 2 of Table-3 corresponding to the platform capability labels. Similarly, the configuration 2 defining the capability tag—“graphics capable” may be defined by a unique combination of settings presented in column 3 of Table-3, for example. Moreover, the configuration 3 defining the capability tag—“low-latency capable” may be defined by a unique combination of settings presented in column 4 of Table-3, for example.

The processing resource 118 may execute one or more of the instructions 122 to assign a capability tag to each of the plurality of member nodes 102-106. In some examples, to assign the capability tag to a given member node (e.g., the member node 102) the processing resource 118 may access the platform capability data corresponding to the given member node from the platform capability data repository 124. Once the platform capability data corresponding to the given member node is accessed from the platform capability data repository 124, the processing resource 118 perform a check to find a configuration from the node capability tag knowledge base 126 that matches with the platform capability data corresponding to the given member node. In one example, the processing resource 118 may allow a predefined tolerance in finding the matching configuration. For example, the processing resource 118 may identify a configuration that matches at least 80% (e.g., with 20% predefined tolerance) with the platform capability data corresponding to the given member node. The processing resource 118 may then identify the capability tag corresponding to the given member node 102 based on the matching configuration identified from the node capability tag knowledge base 126.

In the example implementation of FIG. 1 having the member nodes 102-106 with the respective the platform capability data stored in the platform capability data repository (e.g., Table-2), the processing resource 118 may determine that the configuration 1, configuration 2, and configuration 3 match fully with the platform capability data corresponding to the member node 102, the member node 104, and member node 106, respectively. Accordingly, the processing resource 118 may assign the capability tags corresponding to the configuration 1, configuration 2, and configuration 3, respectively, to the member node 102, the member node 104, and the member node 106. More particularly, the processing resource 118 may assign capability tags “high-performance compute,” “graphics capable,” and “low-latency capable” to the member node 102, the member node 104, and the member node 106, respectively. Assigning the capability tags by the processing resource 118 may include storing a mapping of the member nodes and respective capability tags into a capability tag repository 128. Example mapping of the member nodes 102-106 and respective capability tags stored in the capability tag repository 128 is presented in Table-4.

TABLE 4
Example mapping between the member
nodes and capability tags

| Member Node | Capability Tag |
|---|---|
| 102 | High-performance compute |
| 104 | Graphics capable |
| 106 | Low-latency capable |

Furthermore, in some examples, the management node 108 may receive the runtime performance data about workload resources (WLR1-WLR6) from the respective performance monitors 112-116 hosted on the respective member nodes 102-106. The processing resource 118 may then store the received runtime performance data of workload resources (WLR1-WLR6) into a performance data repository (PDR) 129. The processing resource 118 may then execute one or more of the instructions 122 to determine a resource requirement classification of each workload resource of the workload resources (WLR1-WLR6) based on analysis of runtime performance data of each workload resource. Examples of certain high-level resource requirement classifications may include, but are limited to, a database intense, a memory intense, a compute intense, a graphics intense, or a low-latency demanding.

The term “database intense” as used herein may refer to a type of workload resource that may extensively perform database operations (e.g., MapReduce, Hadoop, MySQL, and MongoDB). Further, the term “memory intense” as used herein may refer to a type of workload resource that may extensively perform memory operations (e.g., SAP Hana, MemSQL, and Redis). Furthermore, the term “compute intense” as used herein may refer to a type of workload resource that may extensively use CPU (e.g., weather forecasting, molecular dynamics, atmosphere modeling, optical tomography, data compression, route planning) on a given member node. Moreover, the term “graphics intense” as used herein may refer to a type of workload resource that may extensively perform graphics related operations (e.g., video processing, ray tracing, image processing, and display management). Also, the term “low-latency demanding” as used herein may refer to a type of workload resource that may demand faster memory access operations, fast inter-process communication (IPC), a high degree of predictability regarding latency, and transaction response times (e.g., large scale stream processing, stock exchange, etc.). It is to be noted that, in certain examples, the resource requirement classifications may also include other high-level classification or more granular classifications (e.g., a read intensive database, write intensive database, memory capacity intensive, a memory bandwidth speed intensive, a CPU core count intensive, a CPU turbo frequency intensive, etc.) in addition to or in alternative to the ones listed hereinabove.

In some examples, the processing resource 118 may execute one or more machine learning (ML) models, for example, a workload classification ML model 130 (labeled as WC MLM 130 in FIG. 1), stored in the machine-readable medium 120 to classify each of the workload resources (WLR1-WLR2) into one of the resource requirement classifications. Examples of the workload classification ML model 130 may include, but are not limited to, a Random Forest classifier, Adaptive Boosting (Ada Boost) algorithm, and K-Nearest Neighbor (KNN) classifier. The processing resource 118 may train the workload classification ML model 130 using a training datasets. In some examples, the training datasets may be generated by executing known workload resources executing known workloads. In one example, the training dataset may be generated by using tools such as a SPEC® SERT® suite which allows various options to execute the different types of known example workloads such as one or more workloads that are database intense, one more workloads that are memory intense, one or more workloads that are compute intense, one or more workloads that are graphics intense, or one or more workloads that are demand low-latency memory operations.

By way of an example, paging is an operating system memory management scheme which includes to performing reads (i.e., operations to read data) and/or writes (i.e., operations to write data) to and from secondary storage (e.g., a physical disk storage) and to a main memory (e.g., RAM) of the computer system. There are two commonly available performance data available in any operating system for paging, for example, “pages inputs per second” and “pages output per second.” The term “pages inputs per second” refers to a number of pages read from the secondary storage that are copied into the main memory and the term “pages output per second” refers to a number of pages written to the secondary storage from the main memory. Therefore, high value of “pages inputs per second” may indicate that a workload running on a given workload resource is having high read activity from the disk. Whereas, high value of “pages output per second” may indicate that a workload running the given workload resource is having high write activity to the disk. Additionally, on a given member node that hosts given workload resource having high paging activity if a high CPU utilization is observed, it may be determined by the processing resource that a big data analytics kind of workload may be running that involves a lot of data analytics. In another example, a workload resource running a workload with high paging activity but low CPU utilization could be a File Transfer Protocol (FTP) server, or an online transaction processing (OLTP) workload. By using the training datasets of such known workloads to train the workload classification ML model 130, the workload classification ML model 130 may gain insights of the workloads by these complex interdependencies of different system telemetry data.

Once the workload classification ML model 130 is trained using the training dataset, the workload classification ML model 130 may be executed by the processing resource 118 to classify each of the workload resources WLR1-WLR6 into one of the resource requirement classifications based on the analysis of runtime performance data of each workload resource stored in the performance data repository 129. In particular, for any given workload resource of the workload resources WLR1-WLR6, the corresponding runtime performance data may be provided as an input to the workload classification ML model 130. In return, the workload classification ML model 130 may suggest one of the resource requirement classification for the given workload resource. The processing resource 118 may store identifiers (e.g., names) of the workload resources WLR1-WLR6 and respective resource requirement classifications into resource requirement classification repository (RRC repository) 132. Table-5 presented below represents an example resource requirement classifications of the WLR1-WLR6 generated by the using the workload classification ML model 130 and stored in the RRC repository 132.

TABLE 5
Example classification of the workload resources

| Member Node | Resource Requirement Classification |
|---|---|
| WLR1 | Graphics intense |
| WLR2 | Compute intense |
| WLR3 | Low-latency demanding |
| WLR4 | Compute intense |
| WLR5 | Low-latency demanding |
| WLR6 | Graphics intense |

Additionally, in some examples, the processing resource 118 may also store and manage (e.g., allow user updates or customizations) a suitable capability tag knowledge base 131 (labeled as SCT KB 131 in FIG. 1) in the machine-readable medium 120. The suitable capability tag knowledge base 131 may include a mapping between some resource requirement classifications and respective suitable capability tags, member nodes corresponding to which may provide suitable platform for execution of the respective workload resources. In some examples, the processing resource 118 may use the suitable capability tag knowledge base 131 to identify (described later) a suitable capability tags for a given resource requirement classification. Table-6 represents an example mapping between the resource requirement classifications and the respective suitable capability tags.

TABLE 6
Example classification of the workload resources

| Resource Requirement Classification | Suitable Capability Tag |
|---|---|
| Compute intense WLR | High-performance compute |
| Graphics intense WLR | Graphics capable |
| Low-latency demanding WLR | Low-latency capable |
| Memory Intense WLR | Storage capable |
| Database intense WLR | Database capable |

Moreover, in some examples, the processing resource 118 may execute one or more of the instructions 122 to determine a temporal usage pattern classification of each workload resource of the workload resource WLR1-WLR6. In some examples, the processing resource 118 may execute one or more machine learning (ML) models, for example, a usage pattern classification ML model 133 (labeled as UPC MLM 133 in FIG. 1), stored in the machine-readable medium 120 to determine the temporal usage pattern classification of each of the workload resources (WLR1-WLR2). Examples of the temporal usage classifications may include, but are not limited to, a periodic pattern, a seasonal pattern, a maintenance pattern, or an unpredictable operation. The usage pattern classification ML model 133 may include any or combinations of a Random Forest classifier, Adaptive Boosting (Ada Boost) algorithm, or K Nearest Neighbor (KNN) classifier. The processing resource 118 may train the usage pattern classification ML model 133 using a training datasets that emulate workloads that demonstrate one or more of a periodic pattern, a seasonal pattern, a maintenance pattern, or an unpredictable operation. By using the training datasets of such known workloads to train the usage pattern classification ML model 133, the usage pattern classification ML model 133 may learn such characteristics which is then used to determine the temporal usage pattern classification of workload resources running on the member nodes 102-106.

In some examples, for a given workload resource, the processing resource 118 may perform a time-series analysis of the respective performance data retrieved from the performance data repository 129. For example, a set of data from the performance data may be plotted over a time scale to identify a pattern over time. In some examples, patterns can be determined using Exponential Smoothening time series statistical analysis. Exponential Smoothening is a forecasting technique wherein more weightage may be given to recent observations and lesser weightage may be given to older observations. Once a forecasting is performed, the usage pattern classification ML model 133 may be calibrated with older data to identify its accuracy. In order to perform this testing, a cross fold validation technique such as a roll forward cross fold validation technique may be performed so that there is no look ahead allowed for an algorithm of the usage pattern classification ML model 133. Once the usage pattern classification ML model 133 is calibrated, the usage pattern classification ML model 133 may help in identifying the short term, long term and seasonal trends of a workload running in the pod or container.

Once the usage pattern classification ML model 133 is trained and calibrated, the usage pattern classification ML model 133 may be executed by the processing resource 118 to classify each of the workload resources WLR1-WLR6 into one of the temporal usage pattern classification based on a time-series analysis of utilization of each workload resource. In one example, the data regarding the utilization of the workload resources may be stored as a part of the performance data in the performance data repository 129. In particular, for any given workload resource of the workload resources WLR1-WLR6, the corresponding runtime performance data (especially, data regarding the utilization of the workload resources) may be provided as an input to the usage pattern classification ML model 133. In return, the usage pattern classification ML model 133 may suggest one of the temporal usage pattern classification for the given workload resource. The processing resource 118 may store identifiers (e.g., names) of the workload resources WLR1-WLR6 and respective temporal usage pattern classifications into a temporal usage pattern classification repository (TUPC repository) 134. In addition, in some examples, the time series analysis of the performance data may also provide information regarding time-durations during which the workload resources WLR1-WLR6 remain idle or inactive. Table-7 presented below represents an example temporal usage pattern classifications of the WLR1-WLR6 generated by the using the usage pattern classification ML model 133 and stored in the TUPC repository 134.

TABLE 7
Example temporal usage pattern
classifications of the workload resources

| Workload | Temporal Usage | Inactive/idle |
|---|---|---|
| Resources | Pattern Classification | Time-durations |
| WLR1 | Periodic Pattern | Every 2 hours beginning |
| | | 12:00 AM |
| WLR2 | Seasonal Pattern | Every year for the entire |
| | | month of December |
| WLR3 | Periodic Pattern | Every day between 10:00 PM |
| | | to 8:00 AM |
| WLR4 | Maintenance Pattern | Last Sunday of every month |
| WLR5 | Periodic Pattern | Every 2 hours beginning |
| | | 12:00 AM |
| WLR6 | Seasonal Pattern | Summers (eg., for the |
| | | months of March and May |
| | | every year) |

In some examples, as depicted in Table-7, the TUPC repository 134 may also include time-durations during which the workload resources remain idle or inactive. The processing resource 118 may determine such time durations based on an analysis of the time series analysis of the utilization of the workload resources and store information about such time-durations in the TUPC repository 134.

Further, in some examples, the processing resource 118 may execute one or more of the instructions 122 to determine a migration plan for a candidate workload resource of the workload resources based on the capability tag of each of the plurality of member nodes 102-106, the resource requirement classification and the temporal usage pattern classification of each workload resource hosted on the member nodes 102-106. Determination of the migration plan, in some examples, may include identifying the candidate workload resource, the target member node to which the candidate workload resource is to be migrated, and a time-schedule during which the migration of the candidate workload resource may be initiated.

To determine the migration plan, the processing resource 118 may execute one or more of the instructions 122 to identify one or more candidate workload resources from the workload resources WLR1-WLR6 that need to be migrated. A given workload resource may be identified as the candidate workload if the given workload resource is determined as hosted on a member node that is not tuned for a resource requirement classification of the given workload resource. To perform such check for the given workload resource, the processing resource 118 may access the resource requirement classification of the given workload resource from the RRC repository 132 and the mapping between resource requirement classifications and respective suitable capability tags stored in the suitable capability tag knowledge base 131. The processing resource 118 may identify the resource requirement classification of the given workload resource based on the data stored in the RRC repository 132. For example, based on the data stored in the RRC repository 132, for the workload resource WLR1, it may be determined that the resource requirement classification is “compute intense”. Further, the processing resource 118 may identify a suitable capability tag for the identified resource requirement classification based on the data stored in the suitable capability tag knowledge base 131. For example, for the resource requirement classification—“compute intense,” the suitable capability tag may be determined as being “high-performance compute.”

Once the suitable capability tag is identified, the processing resource 118 may perform a check to determine whether the capability tag assigned to the given member node hosting the given workload resource is matching with the identified suitable capability tag. For the given workload resource, if both the assigned capability tag and the identified suitable capability tag are different from each other, the processing resource 118 may consider the given workload resource as the candidate workload resource. However, if both the assigned capability tag and the identified suitable capability tag for the given workload resource are same, the processing resource 118 may determine that the given workload resource is not a candidate workload resource and it does not need to be migrated.

For example, for the workload resource WLR1 hosted on the member node 102, the capability tag (e.g., “graphics capable”) assigned to the member node 102 does not match with the identified suitable capability tag (e.g., “high-performance compute”). Accordingly, the processing resource 118 may consider the workload resource WLR1 as a candidate workload resource that is to be migrated to a suitable member node (e.g., a target member node) separate from the member node 102. However, for the workload resource WLR2 hosted on the member node 102, the capability tag (e.g., “graphics capable”) assigned to the member node 102 matches with the identified suitable capability tag (e.g., “graphics capable”) (see Tables 4-6). Accordingly, the processing resource 118 may not consider the workload resource WLR2 as a candidate workload resource. Based on the example implementation of FIG. 1 and above described checks, the processing resource 118 may also identify the workload resources WLR3, WLR4, and WLR6 as the candidate workload resources.

Further, the processing resource 118 may execute one or more of the instructions 122 to determine the target member node based on the capability tag corresponding to each member node 102-106 and the resource requirement classification of the candidate workload resource. For example, as described hereinabove, the processing resource 118 may know a suitable capability tag for each of the workload resources (including the candidate workload resources) based on the respective resource requirement classifications. The processing resource 118 may perform a search in the capability tag repository 128 (see Table-4) to find a member node whose capability tag matches with the suitable capability tag of the candidate workload resource. For example, for the workload resource WLR1 with the suitable capability tag being “high-performance compute,” the processing resource 118 may determine the member node 104 as the target member node. Similarly, for the workload resources WLR3, WLR4, and WLR6, the processing resource 118 may determine the member nodes 106, 102, 104, respectively, as the target member nodes.

Furthermore, in some examples, the processing resource 118 may execute one or more of the instructions 122 to identify a time-schedule suitable to initiate migration of the candidate workload resource based the temporal usage pattern classification of the candidate workload resource. As previously illustrated, in some examples, the TUPC repository 134 may also include, for a given workload resource, information regarding time-durations for which the given workload is inactive or idle. Accordingly, the processing resource 118 may identify a time-schedule as being one or more time-slots from the time-durations when the given workload is inactive or idle based on the data stored in the TUPC repository 134. For example, for the workload resource WLR1, the processing resource 118 may determine the time-schedule as being 12:00 AM to 2:00 AM which falls within the specified idle time-duration “every 2 hours beginning 12:00 AM” (see Table-7). Similarly, the processing resource 118 may determine the time-schedule to initiate migration of the other candidate workload resources WLR3, WLR4, and WLR6 based on mapping of the candidate workload resources and respective idle time-durations stored in the TUPC repository 134.

Once the processing resource 118 has determined one or more candidate workload resources, the respective target member nodes, and time-schedule to initiate the migration of the candidate workload resources, the processing resource 118 may store these information as a migration plan in the migration plan data 136 in the machine-readable medium 120. Table-8 represented below depicts an example migration plan stored in the migration plan data 136.

TABLE 8
Example migration plan

| Candidate | Current | Target | |
|---|---|---|---|
| Workload | Member | Member | |
| Resource | Node | Node | Time-Schedule for Migration |
| WLR1 | 102 | 104 | Between 12:00 AM-2:00 AM |
| WLR3 | 104 | 106 | Between 10:00 PM-8:00 AM |
| WLR4 | 104 | 102 | Any time during last Sunday of |
| | | | a Month |
| WLR6 | 106 | 104 | Anytime between March and |
| | | | May |

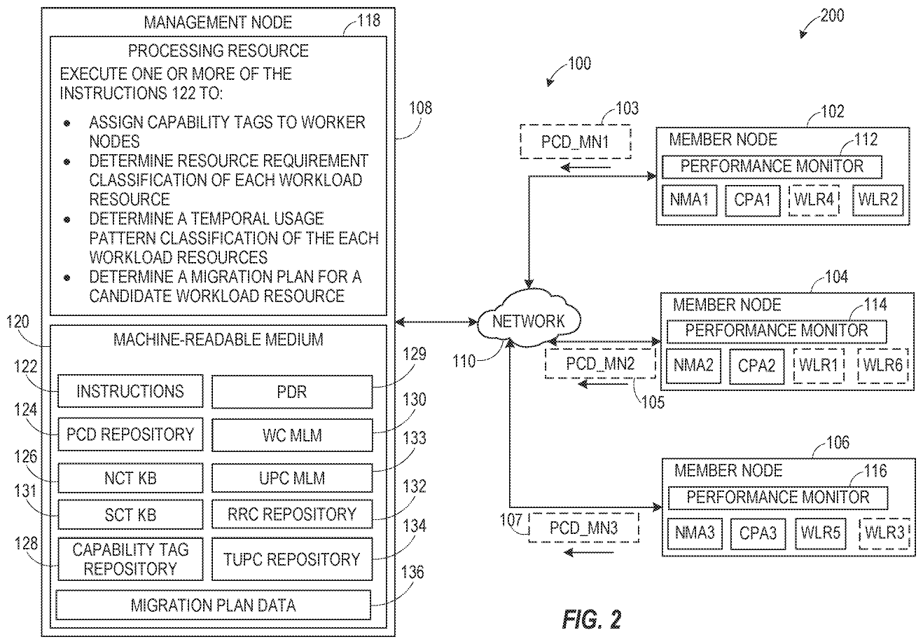

Once the migration plan is determined, the processing resource 118 may execute one or more of the instructions 122 to migrate the candidate workload resource(s) as per the determined migration plan. In some examples, the candidate workload resource(s) may be migrated to the respective target node(s) without application data being lost by using a persistent storage. In some examples, migration of the candidate workload resource(s) may include configuring and deploying the candidate workload resource(s) on the identified target member nodes as recommended in the migration plan data 136. Once the candidate workload resource(s) are deployed on the identified target member nodes, the candidate workload resource(s) are operationalized on the target member nodes. Once the candidate workload resource(s) are operationalized on the respective target member nodes, processing resource 118 may remove these candidate workload resources from current member nodes where the candidate workload resources were running originally. For example, once the candidate workload resources WLR1, WLR3, WLR4, and WLR6 are migrated to the respective target member nodes (see FIG. 2), the candidate workload resources WLR1, WLR3, WLR4, and WLR6 may be removed from the respective current member nodes listed in the migration plan (see Table-8).

FIG. 2 depicts a block diagram 200 of the example networked system 100 after the migration of the candidate workload resources, in accordance with one example. In the example of FIG. 2, the workload resources WLR1 and WLR6 are shown as migrated to the member node 104. Further, the workload resource WLR4 is shown as migrated to the member node 102. Furthermore, the workload resource WLR3 is shown as migrated to the member node 106. In FIG. 2, the migrated resources WLR1, WLR3, WLR4, and WLR6 are marked with dashed outline for illustration purposes.

As will be appreciated, the management node 108, in some examples, may facilitate enhanced migration of candidate workload resources according to the migration plan that is determined based on capability tags that are automatically determined based on platform capability data published by each of the plurality of member nodes, the resource requirement classifications and the temporal usage classifications of the workload resources. Advantageously, by causing the migration of the candidate workload resources based on such a migration plan, user can run workload resources executing business applications with awareness of member nodes' hardware and software capabilities and/or vulnerabilities while taking into account resource requirement classifications and the temporal usage pattern classifications of the workload resources. In particular, enhanced migration of the workload resources as caused by the management node 108, in some examples, may ensure that the workload resources WLR1-WLR6 are executed on a well-equipped member node having sufficient resources (e.g., hardware and software) to fulfill requirements of the workload resources.

Further, the migration of the workload resources (e.g., the candidate workload resources WLR1, WLR3, WLR4, and WLR6) based on the values of the capability tags and the resource requirement classifications may enhance performance of the workload resources on networked systems (e.g., Kubemetes clusters) either in a customer's on-premise private cloud datacenter owned or leased by the customer or consumed as a vendor's as-a-service offering (e.g., through a pay-per-use or consumption-based financial model). In particular, the migration of the candidate workload resources WLR1, WLR3, WLR4, and WLR6 caused in this way may ensure that the candidate workload resources WLR1, WLR3, WLR4, and WLR6 are running on a right kind of hardware. Consequently, allocation of additional compute and storage to the workload resources may be minimized, thereby reducing the overall hardware cost, which, in turn, leads to decrease in the capital expenditure of in the networked system 100.

Moreover, the migration plan that is generated by the management node 108 for a given candidate workload resource (e.g., WLR1, WLR3, WLR4, and WLR6) is also based on a temporal usage pattern classification of the given candidate workload. In particular, in some examples, the migration plan may cause a migration of a given candidate workload resource during a time period when the given candidate workload is inactive or idle. For example, the workload resource that are periodic in nature may be migrated to low-power or less compute intensive member nodes when such periodic workload resources are inactive or idle. Such migration of the candidate workload resources according to respective temporal usage pattern classifications may ensure that the candidate workload resources are not placed statically on the same hardware, thereby reducing the operational expenditure by lowering power and cooling requirements in the networked system 100, for example. Moreover, since the candidate workload resources are migrated when the workload resources are inactive or idle, impact to the performance of the candidate workload resources and violations of SLAs may be avoided.

Referring now to FIG. 3, a flow diagram depicting a method 300 for migrating a workload resource (e.g., a candidate workload resource) is presented, in accordance with an example. For illustration purposes, the method 300 will be described in conjunction with the networked system 100 of FIG. 1, but the method 300 should not be construed to be limited to the example configuration of system 100 (e.g., with respect to quantity of nodes, workloads, etc.). The method 300 may include method blocks 302, 304, 306, and 308 (hereinafter collectively referred to as blocks 302-308) which may be performed by a processor-based system such as, for example, the management node 108. In particular, operations at each of the method blocks 302-308 may be performed by the processing resource 118 by executing the instructions 122 stored in the machine-readable medium 120 (see FIG. 1). In particular, the method 300 may represent an example logical flow of some of the several operations performed by the processing resource 118 to cause migration of candidate workload resources, if any, to respective target member nodes. However, in some other examples, the order of execution of the blocks 302-308 may be different than the order shown in FIG. 3. For example, the blocks 302-308 may be performed in series, in parallel, or a series-parallel combination. Also, certain details of the operations performed by the processing resource 118 that are already described in FIG. 1 are not repeated herein for the sake of brevity.

At block 302, the processing resource 118 may assign a capability tag to each of the plurality of member nodes 102-106 hosting workload resources WLR1-WLR6. Further, at block 304, the processing resource 118 may determine a resource requirement classification of each workload resource of the workload resources WLR1-WLR6 based on analysis of runtime performance data of each workload resource. Furthermore, at block 306, the processing resource 118 may determine a temporal usage pattern classification of each workload resource. Moreover, at block 308, the processing resource 118 may determine a migration plan for a candidate workload resource of the workload resources WLR1-WLR6 based on the capability tag of each of the plurality of member nodes 102-106, the resource requirement classification and the temporal usage pattern classification of the each workload resource.

Moving now to FIG. 4, a flow diagram depicting a method 400 for migrating a workload resource (e.g., a candidate workload resource) is presented, in accordance with an example. For illustration purposes, the method 400 is described in conjunction with the networked system 100 of FIG. 1, but the method 400 should not be construed to be limited to the example configuration of system 100. In particular, the method 400 describes certain additional blocks than the blocks 302-308 described in FIG. 3 and/or some sub-blocks of one or more of the blocks 302-308 described in FIG. 3. The method 400 may include method blocks 402, 404, 406, 408, 410, 412, 414, 416, 418, and 420 (hereinafter collectively referred to as blocks 402-420) which may be performed by a processor-based system such as, for example, the management node 108. In particular, operations at each of the method blocks 402-420 may be performed by the processing resource 118 by executing the instructions 122 stored in the machine-readable medium 120 (see FIG. 1). In some other examples, the order of execution of the blocks 402-420 may be different than the order shown in FIG. 4. For example, the blocks 402-420 may be performed in series, in parallel, or a series-parallel combination. Also, certain details of the operations performed by the processing resource 118 that are already described in FIG. 1 are not repeated herein for the sake of brevity.

At block 402, the processing resource 118 may receive platform capability data from of the member nodes 102-106. In some examples, the platform capability data may be received periodically, on demand by the management node 108, and/or upon any hardware, software, or firmware configuration change in the member nodes 102-106. Further, at block 404, the processing resource 118 may assign a capability tag to each of the member nodes 102-106 based on the platform capability data received from the member nodes 102-106.

In some examples, at block 406, the processing resource 118 may obtain performance data regarding of the workload resources WLR1-WLR6 from the respective member nodes 102-106. In some examples, the platform capability data may be received periodically or on demand by the management node 108 from performance monitors 112, 114, and 116 hosted on the member nodes 102-106. Further, at block 408, the processing resource 118 may determine resource requirement classification of each workload resource of the workload resources WLR1-WLR6 based on analysis of the performance data of each workload resource. Further, at block 410, the processing resource 118 may determine a temporal usage pattern classification of each workload resource based on a time-series analysis of the performance data.

Furthermore, in some examples, at block 412, the processing resource 118 may determine a migration plan based on the capability tag of each of the plurality of member nodes 102-106, the resource requirement classification and the temporal usage pattern classification of the workload resources WLR1-WLR6. The migration plan may include information regarding one or more candidate workload resources (e.g., one or more of WLR1, WLR3, WLR4, and WLR6) identified to be migrated, the target member nodes on which the candidate workload resources are to be migrated, and time-schedule during which the migration of the candidate workload resources may be performed. Accordingly, determination of the migration plan at block 412 may include executing operations at one or more of blocks 414, 416, or 418.

At block 414, the processing resource 118 may identify one or more candidate workload resources from the workload resources WLR1-WLR6 that are to be migrated based on the resource requirement classification of the workload resources WLR1-WLR6 and capability tags assigned to the member nodes 102-106 on which the workload resources WLR1-WLR6 have been executing. Further, at block 416, the processing resource 118 may identify one or more target member nodes of the member node 102-106 based on the capability tag corresponding to each member node 102-106 and the resource requirement classification of the candidate workload resources.

Moreover, at block 418, the processing resource 118 may determine a time-schedule to initiate migration of the candidate workload resource based on the temporal usage classification of the candidate workload resource stored in the TUPC repository 134. Additional details about identifying the candidate workload resources, identifying the target nodes, and determining the time-schedules for migration are described in conjunction with FIG. 1. Once the candidate workload resources and the target nodes are identified, and the time-schedules for migration are determined, the processing resource 118 may store respective information in the migration plan data 136 (see example data shown in Table-8). Additionally, the processing resource 118 may retrieve the migration plan data 136 from the machine-readable medium 120 and execute the migration plan at block 420 by migrating the one or more candidate workload resources (e.g., the workload resources WLR1, WLR3, WLR4, and WLR6) as per the determined migration plan.

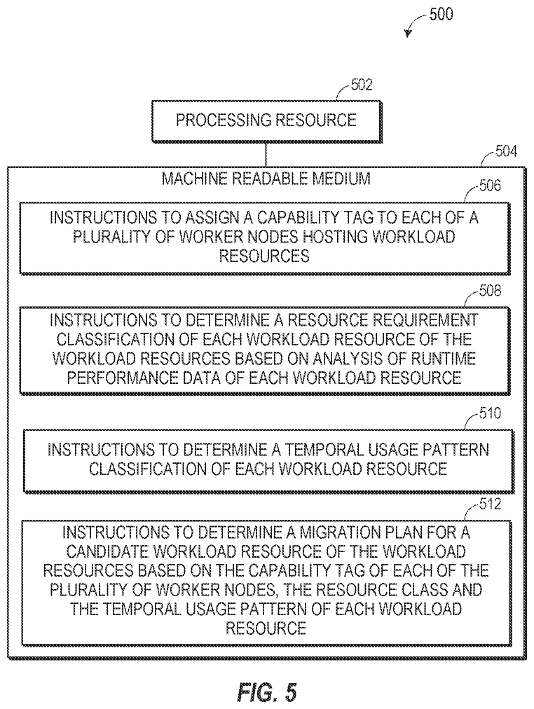

Moving to FIG. 5, a block diagram 500 depicting a processing resource 502 and a machine-readable medium 504 encoded with example instructions to facilitate migration of workload resources is presented, in accordance with an example. The machine-readable medium 504 may be non-transitory and is alternatively referred to as a non-transitory machine-readable medium 504. As described in detail herein, the machine-readable medium 504 may be encoded with executable instructions 506, 508, 510, and 512 (hereinafter collectively referred to as instructions 506-512) for performing the method 300 described in FIG. 3. Although not shown, in some examples, the machine-readable medium 504 may be encoded with certain additional executable instructions to perform the method 400 of FIG. 4, and/or any other operations performed by the management node 108, without limiting the scope of the present disclosure. In some examples, the machine-readable medium 504 may be accessed by the processing resource 502. In some examples, the processing resource 502 may represent one example of the processing resource 118 of the management node 108. Further, the machine-readable medium 504 may represent one example of the machine-readable medium 120 of the management node 108. In some examples, the processing resource 502 may fetch, decode, and execute the instructions 506-512 stored in the machine-readable medium 504 to determine a migration plan for to cause migration of a candidate workload resource.

The instructions 506 when executed by the processing resource 502 may cause the processing resource 502 to assign a capability tag to each of a plurality of member nodes 102-106 hosting the workload resources WLR1-WLR6. Further, the instructions 508 when executed by the processing resource 502 may cause the processing resource 502 to determine a resource requirement classification of each workload resource of the workload resources WLR1-WLR6 based on analysis of runtime performance data of each workload resource. Furthermore, the instructions 510 when executed by the processing resource 502 may cause the processing resource 502 to determine a temporal usage pattern classification of each workload resource. Moreover, the instructions 512 when executed by the processing resource 502 may cause the processing resource 502 to determine a migration plan for a candidate workload resource of the workload resources WLR1-WLR6 based on the capability tag of each of the plurality of member nodes, the resource requirement classification and the temporal usage pattern classification of each workload resource.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. A management node comprising:
a processing resource; and
a machine-readable medium storing instructions that, when executed by the processing resource, cause the processing resource to:
assign a capability tag to each of a plurality of member nodes hosting workload resources;
determine a resource requirement classification of each workload resource of the workload resources based on analysis of runtime performance data of each workload resource;
determine a temporal usage pattern classification of each workload resource; and
determine a migration plan for a candidate workload resource of the workload resources based on the capability tag of each of the plurality of member nodes, the resource requirement classification and the temporal usage pattern classification of each workload resource.

2. The management node of claim 1, wherein the processing resource executes one or more of the instructions to determine the capability tag for each of the plurality of member nodes based on platform capability data published by each of the plurality of member nodes and a node capability tag knowledge base storing a mapping between platform capability data of the plurality of member nodes and capability tags.

3. The management node of claim 1, wherein the capability tag comprises one or more of high-performance compute, graphics capable, low-latency capable, database expert system, power efficient compute, high throughput compute, virtualization efficient system, or special purpose system.

4. The management node of claim 1, wherein the processing resource executes one or more of the instructions to run a workload classification machine-learning model to determine the resource requirement classification of each workload resource of the workload resources.

5. The management node of claim 1, wherein the resource requirement classification comprises any of database intense, memory intense, compute intense, graphics intense, or low-latency demanding.

6. The management node of claim 1, wherein the processing resource executes one or more of the instructions to perform a time-series analysis of the runtime performance data of each workload resource to determine the temporal usage pattern classification.

7. The management node of claim 1, wherein the temporal usage pattern classification comprises one of a periodic pattern, a seasonal pattern, a maintenance pattern, or an unpredictable operation.

8. The management node of claim 1, wherein the processing resource executes one or more of the instructions to identify, based on the capability tag of each of the plurality of member nodes and the resource requirement classification, the candidate workload resource that is to be migrated to a target member node of the plurality of member nodes separate from a member node on which the candidate workload resource is currently running.

9. The management node of claim 8, wherein the processing resource executes one or more of the instructions to identify the target member node based on a capability tag corresponding to each member node and the resource requirement classification of the candidate workload resource.

10. The management node of claim 9, wherein the processing resource executes one or more of the instructions to identify time-schedule to initiate migration of the candidate workload resource based the temporal usage pattern classification of the candidate workload resource.

11. The management node of claim 10, wherein the migration plan for the candidate workload resource comprises information corresponding to the target member node and the time-schedule to initiate migration of the candidate workload resource.

12. The management node of claim 1, wherein the processing resource executes one or more of the instructions to migrate the candidate workload resource as per the migration plan.

13. A method comprising:
assigning a capability tag to each of a plurality of member nodes hosting workload resources;
determining a resource requirement classification of each workload resource of the workload resources based on analysis of runtime performance data of each workload resource;
determining a temporal usage pattern classification of each workload resource; and
determining a migration plan for a candidate workload resource of the workload resources based on the capability tag of each of the plurality of member nodes, the resource requirement classification and the temporal usage pattern classification of each workload resource.

14. The method of claim 13, further comprising determining the capability tag for each of the plurality of member nodes based on platform capability data published by each of the plurality of member nodes and a node capability tag knowledge base storing a mapping between platform capability data of the plurality of member nodes and capability tags.

15. The method of claim 13, wherein determining the migration plan comprises:
identifying, based on the capability tag of each of the plurality of member nodes and the resource requirement classification, the candidate workload resource that is to be migrated to a target member node of the plurality of the member nodes separate from a member node on which the candidate workload resource is currently running;
identifying the target member node based on a capability tag corresponding to each member node and the resource requirement classification of the candidate workload resource; and
determining time-schedule to initiate migration of the candidate workload resource based the temporal usage pattern classification of the candidate workload resource.

16. The method of claim 13, further comprising migrating the candidate workload resource as per the migration plan.

17. A non-transitory machine-readable medium storing instructions executable by a processing resource, the instructions comprising:
instructions to assign a capability tag to each of a plurality of member nodes hosting workload resources;
instructions to determine a resource requirement classification of each workload resource of the workload resources based on analysis of runtime performance data of each workload resource;
instructions to determine a temporal usage pattern classification of each workload resource; and
instructions to determine a migration plan for a candidate workload resource of the workload resources based on the capability tag of each of the plurality of member nodes, the resource requirement classification and the temporal usage pattern classification of each workload resource.

18. The non-transitory machine-readable medium of claim 17, further comprising instructions to determine the capability tag for each of the plurality of member nodes based on platform capability data published by each of the plurality of member nodes and a node capability tag knowledge base storing a mapping between platform capability data of the plurality of member nodes and capability tags.

19. The non-transitory machine-readable medium of claim 17, wherein instructions to determine the migration plan comprises:
instructions to identify, based on the capability tag of each of the plurality of member nodes and the resource requirement classification, the candidate workload resource that is to be migrated to a target member node of the plurality of member nodes separate from a member node on which the candidate workload resource is currently running;
instructions to identify the target member node based on a capability tag corresponding to each member node and the resource requirement classification of the candidate workload resource; and
instructions to determine time-schedule to initiate migration of the candidate workload resource based the temporal usage pattern classification of the candidate workload resource.

20. The non-transitory machine-readable medium of claim 17, further comprising instructions to migrate the candidate workload resource as per the migration plan.
